(19) United States
(12) Patent Application Publication
(10) Pub. No.: US 2006/0088735 A1
(43) Pub. Date: Apr. 27, 2006

(54) Method for manufacturing magnetic disk using cleaning tape

(75) Inventors: Naoto Endou, Kanagawa (JP); Hiroyuki Matsumoto, Kanagawa (JP); Mitsuhiro Shoda, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/257,852

(22) Filed: Oct. 24, 2005

(30) Foreign Application Priority Data
Oct. 27, 2004 (JP) 2004-312469

(51) Int. Cl. G11B 5/65; B05D 5/12

(52) U.S. Cl. 428/833.5; 427/127

(57) ABSTRACT

Embodiments of the invention provide a magnetic disk manufacturing method for efficiently removing, in a tape cleaning process of a magnetic disk surface in which scratches tend to occur, fine protrusions that serve as a flying hindrance, allowing no glide noise to occur, and suppressing minor damages (scratches) that are given to the magnetic disk surface and cause a read signal error. In one embodiment, the magnetic disk manufacturing method is characterized in that a surface of a pad facing a cleaning tape is formed with protrusions and indentations.

### CROSS-REFERENCES TO RELATED APPLICATIONS

This application claims priority from Japanese Patent Application No. JP2004-312469, filed Oct. 27, 2004, the entire disclosure of which is incorporated herein by reference.

### BACKGROUND OF THE INVENTION

The present invention relates generally to a magnetic disk and a method for manufacturing a magnetic disk. More particularly, the present invention relates to a method for manufacturing a magnetic disk by using a cleaning tape for removing dust and dirt deposited on a surface of the magnetic disk or an abnormally protruded portion occurring in a forming process of medium film or the like.

With the recent development in information industry, performance requirements of computers are becoming more and more stringent at an accelerated pace. There are growing needs in magnetic recording media for an even more compact body, a greater recording density, and more enhanced reliability.

A common method for manufacturing magnetic disks includes, for example, the following steps. Specifically, a glass substrate with fine concentric lines (hereinafter referred to as a “texture”) made on a mirror-ground surface thereof is loaded in a vacuum system. An underlayer, a magnetic layer, and a protective layer are then formed in that order through sputtering. The surface is then coated with a lubricant and cleaned. This completes the manufacturing procedures. Recently, there is also a demand for reduced spacing between a read/write magnetic head and a magnetic disk, which is indispensable for greater recording densities. To achieve this end, surface roughness of the glass substrate is becoming smaller and smaller: about 2 nm in terms of protrusion height (hereinafter referred to as “Rp”) and 0.4 nm or less in terms of centerline average roughness (hereinafter referred to as “Ra”). In addition, there is another need for an even greater reduction in the amount of dust and dirt that hampers flying of the magnetic head or an abnormal protrusion exceeding a flying height. Further, permissible size of a minor damage (hereinafter referred to as a “scratch”) causing a read/write error is becoming extremely small.

To assure reduction in the flying height, conventional cleaning methods are known, in which a tape film having abrasive grains fixed on an abrasive layer (hereinafter referred to as a “cleaning tape”) is pressed through various techniques to perform cleaning. For example, one technique for pressing uses a rubber roller as disclosed in Patent Document 1 (Japanese Patent Publication No. 6-52568) or 2 (Japanese Patent Laid-open No. 2003-136389). Another conventional technique for pressing uses a foam as disclosed in Patent Document 3 (Japanese Patent Laid-open No. 2001-67655). Still another conventional technique for pressing is a cleaning tape as disclosed in Patent Document 4 (Japanese Patent Laid-open No. 2000-348337). The cleaning tape as disclosed in Patent Document 4 has deep chip pockets and small-diameter grains on its surface. It is known that these arrangements help minimize scratches and effectively remove abnormal protrusions.

### BRIEF SUMMARY OF THE INVENTION

In later magnetic disk manufacturing processes, however, the criterion for permissible protrusion defects has become even more stringent to achieve a reduced spacing and ensure greater reliability. This means that there are involved more protrusions to be removed using the tape cleaning process than in conventional cases. This makes it necessary to enhance the polishing performance. Possible techniques for achieving that purpose may be to extend the processing time and processing distance, or increase the processing pressure. These techniques for enhancing the polishing performance, however, mean the protective layer and the lubrication film are becoming thinner for reduced spacing. Any of these techniques therefore helps increase the damage (scratch) on the surface of the magnetic disk.

The technique using a sponge-like foam pressed against the cleaning tape as disclosed in Patent Document 3, on the other hand, has the following drawbacks. Specifically, the form takes a longer time than rubber to restore to its original state from a contracted state. The shape of contact, or an area of contact, at repeated pressurization is not stable in terms of repeatability. Further, the foam is not good for a material used in mass production processes because of unstable polishing performance involved.

The perpendicular magnetic recording medium, on the other hand, is being studied as a magnetic recording medium for possible applications to meet a later trend in need for significantly higher recording densities. The perpendicular magnetic recording medium has a number of layers, including an adhesion layer, a soft magnetic layer, an underlayer, a magnetic layer, and a protective layer stacked on a substrate. The layers of the perpendicular magnetic recording medium are therefore several times as thick as the longitudinal magnetic recording medium. There is therefore a better chance of protrusions that serve as a hindrance to flying occurring through sputtering and then growing abnormally. Furthermore, the following facts have been found when the conventional tape cleaning technique is used with the perpendicular magnetic recording medium. Specifically, the use of the conventional tape cleaning technique with the perpendicular magnetic recording medium results in the number of scratches being substantially increased. A phenomenon (hereinafter referred to as “glide noise”) also occurs, in which the average output value of piezo for one track (hereinafter referred to as “Have”) becomes high in flying of a glide check head. The phenomenon results in unstable flying.

The present invention thus provides a magnetic disk manufacturing method for efficiently removing, in the tape cleaning process of a magnetic disk surface in which scratches tend to occur, fine protrusions that serve as a flying hindrance, allowing no glide noise to occur, and minimizing the minor damage or scratches that are given to the magnetic disk surface and cause a read signal error.

In one aspect of the present invention, the magnetic disk manufacturing method is characterized in that a surface of a pad facing the cleaning tape is formed with protrusions and indentations. For the cause of the scratches, it is probable that particles grown abnormally as a result of sputtering and polishing scraps produced from the cleaning are sandwiched between the magnetic disk surface and the cleaning tape, and slight scratches occur when the particles and the polishing scraps are compressed in the sandwiched state. To avoid a condition, in which a high pressure is applied locally to the portion where the particles and the polishing scraps are sandwiched, a waffle-like surface having protrusions and indentations is formed on the surface of the pad facing the cleaning tape.

In addition, the above magnetic disk fabrication method is characterized in that an elastic body, or soft rubber in particular, is used for the pad. This eliminates the conventional problem arising from the tape cleaning technique to which the aforementioned foam is applied. Stable processing performance can thus be achieved.

According to the present invention, efficient removal of protrusions, stable flyability not producing the glide noise, and reduction in the scratches causing errors can all be achieved, which has not been possible with the conventional pad. In addition, effective removal of protrusions and reduction in the scratches can both be achieved even by increasing a contact surface pressure for an improved processing performance or a relative speed of the disk and the cleaning tape during processing.

### BRIEF DESCRIPTION OF THE DRAWINGS

FIG. 1 is a cross-sectional view showing a structure of a magnetic disk according to a first embodiment of the present invention.

FIG. 2 is a cross-sectional view showing a structure of a magnetic disk according to a third embodiment of the present invention.

FIG. 3 is a view showing a cleaning system used in the first embodiment.

FIGS. 4A and 4B are views showing schematically shapes of a conventional pad and a pad used in the first embodiment, respectively.

FIG. 5 is a graph showing the relationship between a rotating speed of the magnetic disk and glide noise counts according to the first embodiment.

FIG. 6 is a graph showing the relationship between the disk rotating speed and scratch counts on the disk surface according to the first embodiment.

FIG. 7 is a graph showing the number of readings taken by a piezo element in a flying test conducted using a glide check head, comparing a case in which the conventional pad is used in the tape cleaning system according to the first embodiment, with a case in which the waffle pad according to the first embodiment is used in the tape cleaning system of the first embodiment.

FIG. 8 is a graph comparing the missing error counts of the waffle pad according to the first embodiment with the missing error counts of the conventional pad.

FIG. 9 is a graph showing the relationship between the thickness of a protective layer and scratch counts according to a second embodiment.

FIG. 10 is a graph showing the relationship between the ratio of a bonding layer thickness to a total thickness of a lubricant layer and scratch counts according to a second embodiment of the present invention.

FIG. 11 is a graph showing an Have value of the waffle pad according to a third embodiment of the present invention as applied to a magnetic disk according to a third embodiment compared with an Have value of the conventional pad.

FIG. 12 is a graph showing the number of protrusions detected by a glide check head with the waffle pad according to the third embodiment as applied to the magnetic disk according to the third embodiment invention compared with the number of protrusions detected by the glide check head with the conventional pad.

FIG. 13 is a chart showing a scratch evaluation acceptance rate of the magnetic disk according to the third embodiment compared with the conventional magnetic disk.

### DETAILED DESCRIPTION OF THE INVENTION

A magnetic disk manufacturing method, a magnetic disk, a tape cleaning system, and a pad according to an exemplary embodiment of the present invention will be described with reference to the accompanying drawings. In the drawings to be cited hereunder, a characteristic portion or the like may be enlarged for ease of understanding. Actual dimensions may, however, differ from what they appear. In addition, materials for the different layers making up the magnetic disk will be presented. The present invention is not, however, limited to those materials. Different structures or materials may be selected for the layers depending on specific purposes and performance. The general concept of the present invention will first be described.

The applicant first examined optimization of tape cleaning conditions in order to efficiently remove protrusions that serve as a hindrance to flying of the magnetic head over a magnetic recording medium and reduce glide noise.

To enhance processing efficiency, the applicant also increased the number of times the disk surface came in contact with the abrasive grains by increasing the relative speed of the disk and the tape during processing. It was found as a result that the higher the relative speed, the greater the removal rate of protrusions and thus the more the glide noise is reduced. This, however, resulted in the problem of an increased error count.

An output signal error mode during read/write processes of the magnetic disk will be described. The term “error” used herein refers to what is called a missing error. The missing error is a phenomenon in which an output level is reduced, as caused by a defect of a partially missing, partially indented, or otherwise damaged cobalt alloy magnetic layer responsible for magnetic recording. Through the aforementioned examination made by the applicant, it is probable that there is a greater likelihood that a defect of a missing protective layer or the protective layer being indented will occur when protrusions existing in a lower portion of the magnetic layer or an upper layer including the magnetic layer are removed. This is traded in, though, for the effect of the enhanced processing efficiency produced by increasing the relative speed. It is estimated that the defect by indentation occurs from the following. Specifically, the processing scraps, abrasive grains that have come off the tape, or the like are sandwiched between the magnetic disk surface and the cleaning tape. That specific part is pressed by the pad and a locally high pressure thus applied produces an indentation. The inventors therefore invented the following pad in order to circumvent the condition, in which a locally high pressure is applied to the sandwiched processing scraps or abrasive grains that have come off the tape. Specifically, the surface of the pad giving the pressure is formed to have protrusions and indentations. Areas of the indentations help alleviate the pressure by functioning as a pocket, in which foreign objects, if included between the magnetic disk surface and the cleaning tape, can escape. As compared with the conventional pad, the invented pad offers a high removal rate of protrusions and helps reduce the number of errors. Specific embodiments of the present invention will be described in detail with reference to the accompanying drawings.

### Embodiment 1

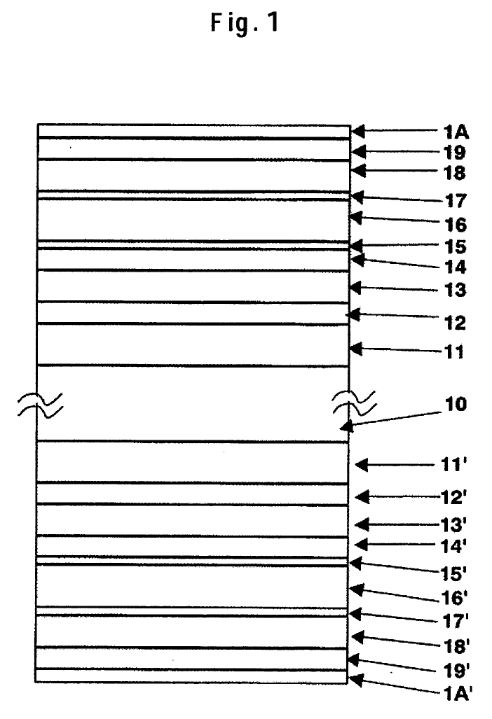

FIG. 1 is a cross-sectional view showing a structure of a magnetic disk according to a first embodiment of the present invention. The magnetic disk according to the first embodiment of the present invention is fabricated as below. Specifically, an 18-inch aluminosilicate glass substrate 10 with chemically strengthened surfaces is used. The aluminosilicate glass substrate 10 has a thickness of 0.508 mm and surface roughness of Rp=1.8 nm and Ra=0.4 nm as measured with an atomic force microscope (hereinafter referred to as an “AFM”) on 25 μm². Further, a texture with a linear density of 5 to 10 lines/25 μm² is provided on the surface. Multiple layers are then formed on the glass substrate 10 using a sheet type sputtering apparatus (MDP250B) manufactured by Intevac, Inc. that runs with a tact time of 6.8 sec. The following procedures are used. Each of the multiple layers is formed on both sides of the substrate simultaneously.

A first underlayer 11, 11′ including a 14-nm-thick Co-50 at % Ti-10 at % Ni alloy is formed on the substrate 10. A second underlayer 12, 12′ including a 3-nm-thick W-30 at % Co alloy is formed on the first underlayer 11, 11′. The substrate 10 is then heated to about 390° C. using a lamp heater. The substrate 10 is then exposed to an ambience of a 99% Ar-1% O2 mixed gas under a pressure of 0.6 Pa for 4.2 sec. in an oxidation chamber. A third underlayer 13, 13′ including a 7-nm-thick Cr-10 at %Ti-3 at % B alloy is formed on the second underlayer 12, 12′. A first magnetic layer 14, 14′ including a 2.4-nm-thick Co-16 at % Cr-9 at % Pt alloy is formed on the third underlayer 13, 13′. A first intermediate layer 15, 15′ including a 0.5-nmn-thick Ru is formed on the first magnetic layer 14, 14′. A second magnetic layer 16, 16′ including a 12.3-nm-thick Co-16 at % Cr-12 at % Pt-8 at % B alloy is formed on the first intermediate layer 15, 15′. A second intermediate layer 17, 17′ including a 0.6-nm-thick Ru is formed on the second magnetic layer 16, 16′. A third magnetic layer 18, 18′ including a 8.4-nm-thick Co-14 at % Cr-14 at % Pt-8 at % B-2 at % Ta alloy is formed on the second intermediate layer 17, 17′. A protective layer 19, 19′ including a 2.7-nm-thick carbon as a main ingredient is formed on the third magnetic layer 18, 18′. The substrate 10 is then unloaded from the sputtering apparatus. A 1-nm-thick lubricant layer 1A, 1A′ is formed on the protective layer 19, 19′ by applying a lubricant having perfluoroalkylpolyether as a main ingredient.

The magnetic disk surface may be cleaned using a cleaning tape applied to the protective layer. It is, however, preferable that cleaning be performed over the lubricant layer applied on top of the protective layer using the cleaning tape as embodied in the first embodiment of the present invention. The cleaning procedure carried out after the lubricant layer has been applied has the following effect. Specifically, a friction force applied to a surface of a layer being ground is reduced, which helps minimize the minor scratches that serve as a factor responsible for an error.

The cleaning tape according to the first embodiment of the present invention has grooves in a surface of an abrasive layer thereof. These grooves form a large number of polygonal (quadrilateral to octagonal) chip pockets. For the cleaning tape, AWA15000TNY-D manufactured by Nihon Micro Coating Co., Ltd. was used. The cleaning tape has an abrasive grain diameter of 0.3 μm. The material for the abrasive grains is an aluminum oxide. The abrasive grain is a curved surface structure having no edges thereon, which is preferable in terms of shape and helps minimize the occurrence of scratches.

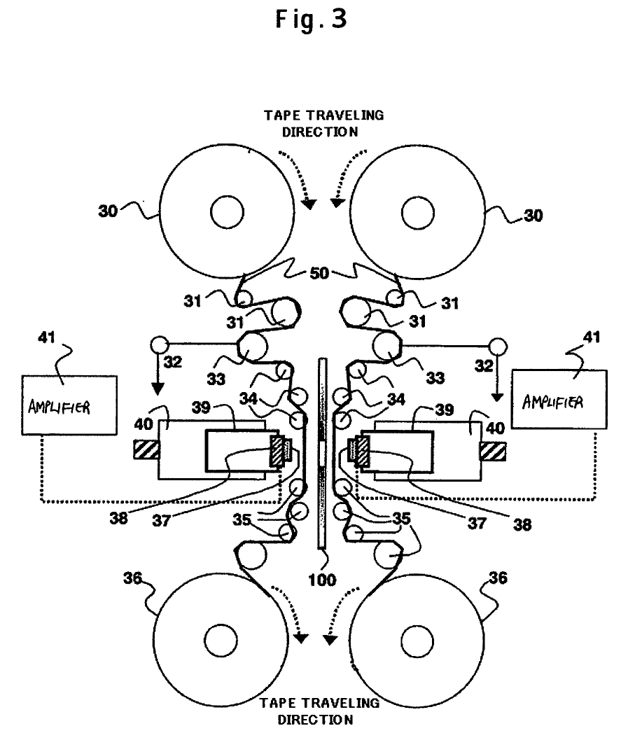

FIG. 3 is a view showing a cleaning system used in the first embodiment of the present invention. The inventors applied the aforementioned cleaning tape to the cleaning system shown in FIG. 3 and carried out cleaning of a magnetic disk. The cleaning system includes a pair of mechanisms for cleaning both sides of a magnetic disk 100. Each of the mechanisms includes a reel 30, guide rollers 31, a constant tensioning mechanism 32, guide rollers 34, a pressure mechanism including an elastic body (hereinafter referred to as a “pad”) 37, and a take-up roller 36. The reel 30 feeds a cleaning tape 50 wound around the reel. The guide rollers 31 guide the cleaning tape 50 fed off from the reel 30. The constant tensioning mechanism 32 uses an air cylinder to apply tension to the cleaning tape 50 fed between the guide rollers 31 and a guide roller 33. The guide rollers 34 guide the cleaning tape 50, to which the tension is applied, onto a surface of the magnetic disk 100. The pressure mechanism including the pad 37 lets the cleaning tape 50 slide over the surface of the magnetic disk 100 with a predetermined pressure by pressurizing the cleaning tape 50 guided onto the surface of the magnetic disk 100 using the pad 37. The take-up roller 36 takes up the cleaning tape 50 that has undergone the cleaning process via guide rollers 35.

The cleaning system structured as described in the foregoing applies a predetermined pressure to the cleaning tapes 50 such that the tapes 50 are brought into contact with the corresponding surfaces of the magnetic disk 100 which is kept rotating. The cleaning system thereby cleans both sides of the magnetic disk 100 simultaneously. The cleaning tape 50 is 12.6 mm wide. When the cleaning tape 50 contacts the magnetic disk 100 and the predetermined pressure is thereafter reached, the cleaning tape 50 is moved radially from an inner periphery to an outer periphery over the magnetic disk 100. Thus, the entire recording surfaces of the 1.8-inch-diameter magnetic disk 100 are cleaned.

An experiment was conducted on the cleaning with a sequence of a constant circumferential velocity, at the rotating speed of magnetic disk 100 covering 1 to 5 m/s. The contact pressure of the cleaning tape on the magnetic disk surface is controlled at this time by the pressure mechanism that presses the pad 37 against the disk surface at a predetermined pressure. A base portion, on which the pad 37 is mounted, serves as a strain gage sensor 38. The pressure control is a feedback system working as detailed in the following. When the pad 37 contacts the magnetic disk 100 via the cleaning tape 50, a stress strain is produced in the strain gage sensor 38. A strain output caused by the stress strain is given as a voltage signal to an amplifier 41. The voltage signal is then converted to a corresponding pressure value. A command is then issued to a servomotor so as to maintain a predetermined pressure. The servomotor then drives a pressure base portion 40 by way of a ball screw.

To stabilize the pressure or pressing force, the strain gage sensor 38 is mounted on a slide mechanism 39 with a low coefficient of friction. In the embodiment of the present invention, the cleaning tape is pressed with an ultimate pressure of 30 gf by the pressure mechanism for cleaning the magnetic disk surface. At the completion of the cleaning sequence, that is, when the tape has left the disk surface on the outer periphery thereof, the cleaning tape is fed a distance equivalent to or more than the length of the pad in a longitudinal direction of the tape for each disk.

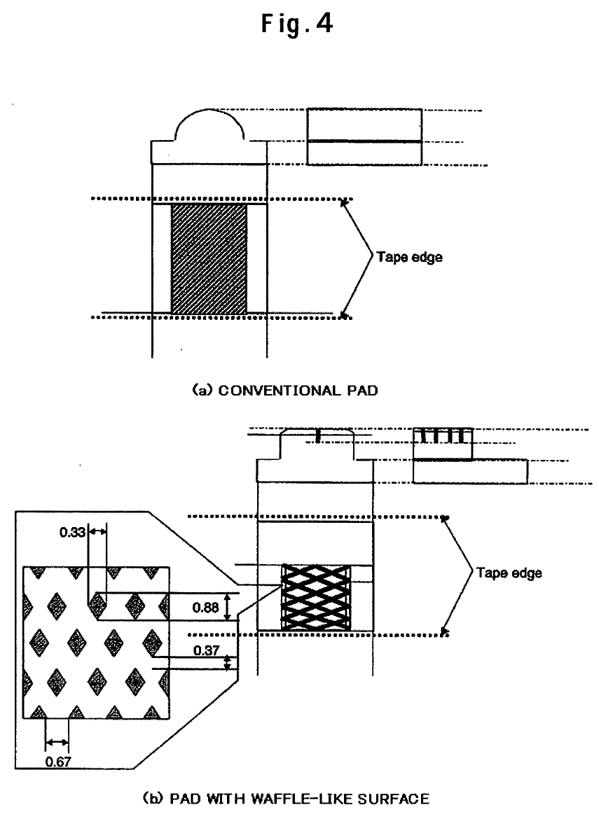

FIGS. 4A and 4B schematically illustrate the conventional pad and the pad used in the first embodiment of the present invention, respectively. The conventional pad that the inventors have used is of a curved surface structure having a curved surface in contact with a non-processing surface of the tape (hereinafter referred to as the “conventional pad”). The conventional pad has a hardness of 25 degrees (as measured at room temperature) and is formed of an ester-based polyurethane rubber. A surface of the pad used in the first embodiment of the present invention, facing the cleaning tape or the protective layer of the magnetic disk, on the other hand, is formed in a waffle-like shape having protrusions and indentations (hereinafter referred to as a “waffle pad”). To state it another way, the waffle pad features a structure having different hardness values on its surface facing the protective layer of the magnetic disk. The same ester-based polyurethane rubber is used as the conventional pad with a hardness of 25 degrees (as measured at room temperature). While the ester-based polyurethane rubber is used in the first embodiment of the present invention, the material used with the present invention is not limited thereto. Rather, any rubber will do having a hardness of about 20 to 40 degrees (as measured at room temperature).

The reason for the use of rubber for the pad is the inventors' advance knowledge of the following. Specifically, if a porous foam such as a sponge is used in such applications that require repeated application of a pressure as in the embodiment of the present invention, the pad deforms greatly with time. This leads to an unstable contact area, resulting in a surface pressure per unit area becoming unstable. The material is not right for mass production. By setting a rubber hardness to about 20 to 40 degrees (as measured at room temperature), desired elasticity can be retained and a stable contact pressure can be maintained without allowing the shape to change with time.

The waffle pad has the following dimensions relative to the magnetic disk according to the first embodiment of the present invention. Specifically, the waffle pad measures about 5 mm long in the longitudinal direction of the cleaning tape (the indirection in which the cleaning tape is fed by the guide rollers), and about 4 mm wide in a crosswise direction of the cleaning tape. These specific dimension values allow the waffle pad to be disposed on the magnetic disk such that there is no overlap of areas of contact between the magnetic disk and the waffle pad.

The pattern of protrusions and indentations of the waffle pad forms a regular array. The area ratio of the indentations is 74% of the total area of protrusions and indentations. The contact-surface of each of the protrusions is a rhombus. The shape of the rhombus, or a quadrilateral, means that a gap between the quadrilateral protrusions forms a groove having a predetermined angle. The angle of the groove is such that the rotating speed of the magnetic disk during tape cleaning and a velocity vector combined by a relative traveling speed of the tape in the radial direction of the disk and that of the magnetic disk coincide with each other. To state it another way, the groove formed by the indentations of the pad coincides with a combined direction of the radial direction of the magnetic disk and a direction tangential to the rotating direction. This yields conditions where protrusions can be efficiently removed and scratches are less liable to occur. According to the first embodiment of the present invention, there are arranged a total of ten rhombus-shaped protrusions with the dimensions shown in FIG. 4(b) and twelve semi-rhombuses on end portions of the pad.

According to the first embodiment of the present invention, it is preferable that the height of the protrusions of the pad be 0.3 mm or more. Given a height of less than 0.3 mm, the protrusions collapse as the protrusions are brought into contact with the protective layer of the magnetic disk via the cleaning tape. As a result, the entire surface of the pad comes in contact with the magnetic disk.

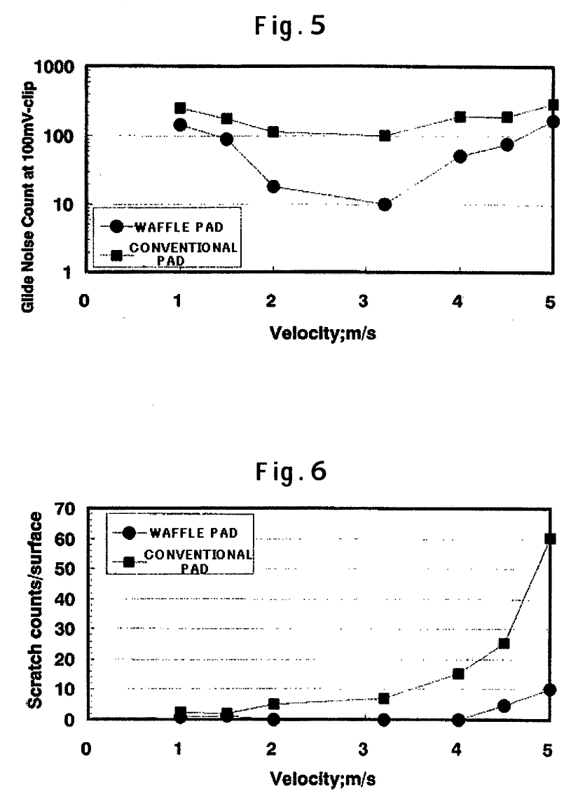

Results of cleaning the above-mentioned surface of the magnetic disk under the conditions noted above will be described below. FIG. 5 shows results obtained by examining the relationship between glide noise counts or protrusion removal performance and the rotating speed of the disk, using the waffle pad and the conventional pad. A two-rail type glide check head was used for the glide noise count flying test. The flying height of the head was 7 nm. The number of readings taken by a piezo element with an amp gain of 260 dB was measured at a slice level of 100 mV. It was found that the waffle pad of the embodiment yields a smaller glide noise count than the conventional pad. In addition, the glide noise count of the waffle pad is the smallest at a velocity near 3 m/s. This is probably due to the following reasons. Specifically, the lower the rotating speed, the lower is the energy for contact of the tape with the disk surface and the lower the frequency of contact of the abrasive grains of the tape with the disk surface. As a result, processing performance is degraded. If the rotating speed exceeds a predetermined value, on the other hand, the friction force between the tape surface and the disk surface becomes greater. This causes the alumina to dissolve the lubricant, thus producing glide noise.

FIG. 6 shows a relationship between the disk rotating speed and a scratch count on the disk surface. Scratches were measured using an optical surface analyzer (OSA: TS-2120 manufactured by Candela Instruments). Specific measurement conditions were as follows: S-Specular channel; threshold=0.22; and the minimum pixel size=5. Flaws were detected as scratches when the flaws have a radial-to-circumferential length ratio of 0.1 or less. In both the waffle pad and the conventional pad, the scratch count tends to increase as the disk rotating speed increases. This is due to the following reason. Specifically, when the rotating speed increases, the friction force between the tape and the disk surface becomes larger, which increases the damage to the disk surface. It was found, based on these results, that, to efficiently remove protrusions and minimize scratches, it would be effective to use the waffle pad and set the disk rotating speed to a level within a predetermined range. It is desirable that the rotating speed be set in the range from 2 to 4 m/s.

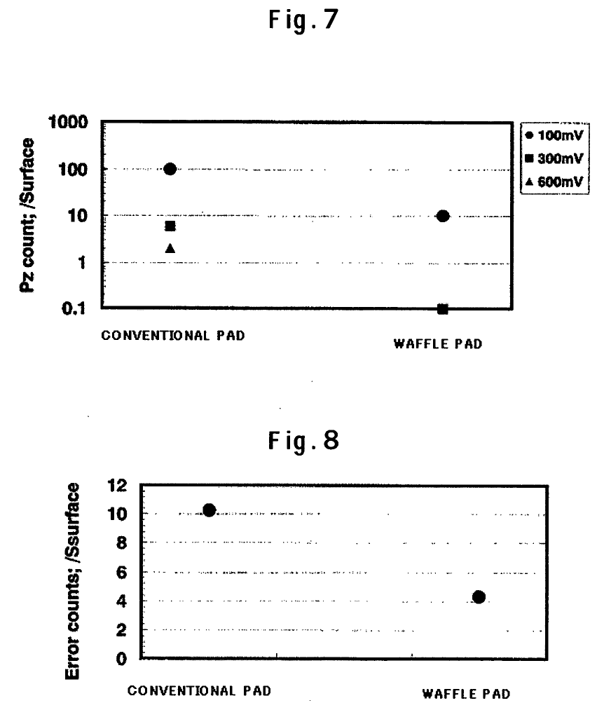

Results of a thorough comparison made of the head flyability, or the glide noise count, and the missing error caused by scratches will be described. In this comparison, the disk rotating speed was set to 3.2 m/s which resulted in the minimum glide noise count and scratch count as found from the aforementioned results. FIG. 7 shows the number of readings taken by the piezo element in a flying test conducted using the glide check head. FIG. 7 compares the piezo counts between the conventional pad and the waffle pad according to the first embodiment shown in FIGS. 4A and 4B, respectively, mounted on the tape cleaning system shown in FIG. 3. The flying test used a two-rail type glide check head. The number of readings taken by the piezo element were measured with a head flying height of 7 nm, an amp gain of 60 dB, and slice levels of 100 mV, 300 mV, and 600 mV. From the results, it is seen that the piezo count in any of the slice levels of 100 mV, 300 mV, and 600 mV is decreased with the waffle pad according to the first embodiment of the present invention, as compared with the conventional pad.

FIG. 8 compares the missing error counts between the two pads. The missing error counts were measured by using a magnetoresistive head with a track width of 0.5 μm under the following conditions: frequency 145 kFCI; speed 8400 rpm; slice level 75%; track width 0.5 mm; and an auto gain control function turned off for all tracks. Each missing error count represents an average value of 100 measurements taken, each measurement being the number of defects per surface of a size ranging from 0.175 to 11.2 mm. It was found that the error count is decreased to substantially half by using the waffle pad, as compared with using the conventional pad. It is probable that the reasons for simultaneous reduction in both the piezo count and the error count when the waffle pad is used are as below. Specifically, the area of contact with the tape is wider in the waffle pad than in the conventional pad. This allows a processing distance for the same processing time to be made longer, which enhances removal performance of protrusions detected by the piezo element. In addition, the waffle-like shape presents two types of portions: portions (protrusions) that are practically pressed, or pressed with a locally high pressure by the pad; and portions (indentations) that are not directly pressed. Should the particles that can be a cause of an error be sandwiched between the tape and the disk surface, the portions (indentations) that are not directly pressed serve to disperse the pressure and absorb particles. This helps prevent minor indentations and damage causing an error from occurring.

### Embodiment 2

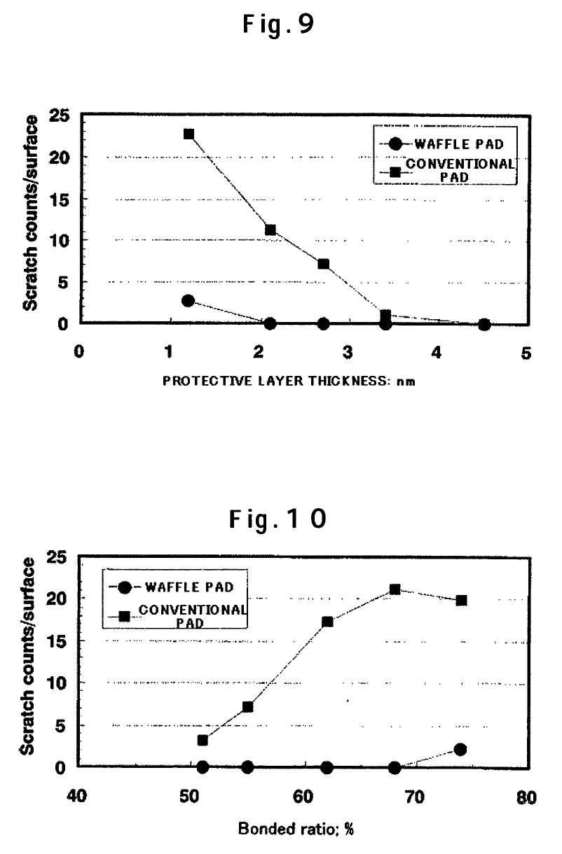

Further, the inventors experimentally found that the ease with which scratches occur is greatly influenced by the protective layer and the lubricant layer on the surface of the magnetic disk. First, for the relationship with the protective layer, FIG. 9 shows the relationship between the thickness of the protective layer and the scratch counts. The same cleaning tape conditions were used herein as in Embodiment 1. The thinner the protective layer, the more the scratch counts there are after tape cleaning. As recording densities increase, it becomes indispensable to reduce spacing between the magnetic recording disk and the magnetic disk. There is therefore a continuing trend toward even thinner protective layers. Hence the techniques for reducing the scratches are further required.

As shown in FIG. 9, the inventors found that the use of the waffle pad prevents scratch counts from increasing sharply even with the protective layer becoming as thin as up to 1 nm. In contrast, the use of the conventional pad steeply increases the scratch counts with the protective layer being about 3 nm or less in thickness. With the 3-nm-thick protective layer, the conventional pad is unable to surround or enclose particles and other foreign matter, allowing the particles and other foreign matter to be embedded under the protective layer, which results in scratches. With the waffle pad according to the embodiment of the present invention, on the other hand, the indentations in the pad help alleviate pressure for the particles and matter coming off the tape that are the causes of scratches as described about Embodiment 1. These particles and matter coming off the tape are not therefore embedded in the protective layer. It is therefore probable that the indentations in the pad are able to enclose the particles and matter coming off the tape.

The scratches also greatly affect a layer construction of the lubricant layer. Specifically, the inventors found that the ratio of a bonding layer, which is bonded to an adsorptive site on the surface of the protective layer, to a loose layer existing without being bonded thereto affects the ease with which scratches occur. FIG. 10 shows a relationship between the ratio of the bonding layer thickness to the total thickness of the lubricant layer (hereinafter referred to as a “bonded ratio”) and the scratch counts. If the conventional pad is used, the scratches suddenly increase when the bonded ratio is 60% or more. This is probably attributable to the following fact. Specifically, the higher bonded ratio or the smaller thickness of the loose layer means to reduce the thickness of the lubricant layer serving to offer fluid lubrication. The lubricant layer functions to reduce the friction force between the abrasive grains on the surface of the cleaning tape and the protective layer. The thinned lubricant layer consequently increases the friction force, thus increasing the scratches. It was found that, if the waffle pad according to the embodiment is used, on the other hand, the scratches do not increase even with the bonded ratio becoming 60% or more. This is probably attributable to the following reason. Specifically, with the waffle pad, the loose layer of the lubricant layer being scraped together when the tape is pressed is not significantly lost where the pressure is alleviated in areas of indentations on the surface of the pad. There is therefore no increase in the friction force during cleaning.

As described in the foregoing, the inventors have invented the magnetic disk manufacturing method capable of effectively removing protrusions otherwise causing a hindrance to flying even when the protective layer is about 3 nm or less thick and the bonded ratio is about 60% or more. The manufacturing method carries out the tape cleaning process characterized in the following points. Specifically, the pad for pressing the cleaning tape is made of soft rubber having a hardness of about 20 to 40 degrees (as measured at room temperature). The surface of the pad for pressing the cleaning tape includes protrusions and indentations. In addition, the ratio of the area of the indentations to the overall area of the protrusions and indentations ranges between about 20 and 80%.

### Embodiment 3

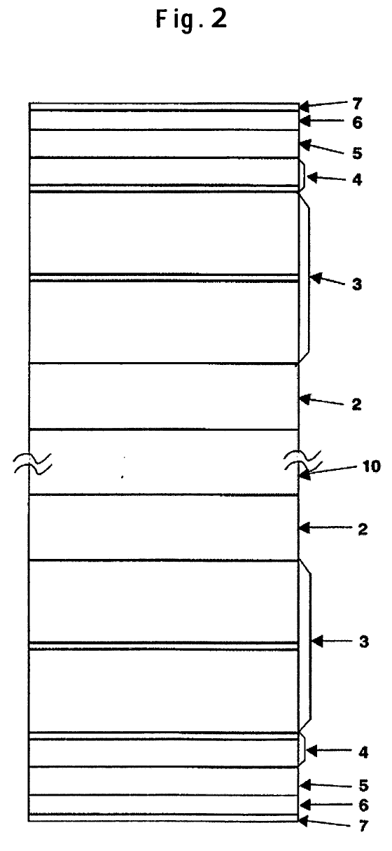

Furthermore, the inventors tested effects of the present invention as applied to a perpendicular magnetic recording disk. The perpendicular magnetic recording disk is being developed at a remarkably rapid pace toward commercialization as the state-of-the-art technology toward higher recording densities. First of all, a structure and a manufacturing method of the perpendicular magnetic recording disk to be embodied as a third embodiment of the present invention will be described with reference to FIG. 2 showing a cross-sectional structure of the magnetic disk.

The magnetic disk according to the third embodiment of the present invention is fabricated as below. Specifically, a 2.5-inch aluminosilicate glass substrate 10 with chemically strengthened surfaces is used. The aluminosilicate glass substrate 10 has a thickness of 0.635 mm and surface roughness of Rp=1.8 nm and Ra=0.45 nm as measured with the AFM on 25 μm². Further, a texture with a linear density of 5 to 10 lines/25 μm² is provided on the surfaces. Multiple layers are then formed on the glass substrate 10 using the sputtering apparatus (A3040) manufactured by Anelva Corp. The following procedures are used to form the multiple layers.

Each of the multiple layers is formed on both sides of the substrate simultaneously. The glass substrate 10 is then loaded in continuous multilayered sputtering apparatus. For a contact layer 2, a Ni40Ta target is used and a DC-Power of 500 W is applied at an Ar pressure of 1.25 Pa using a DC magnetron cathode, thus forming a 30-nm-thick film. Next, as a soft magnetic layer 3, a 50-nm-thick film of Co10Ta5Zr is formed and then 1-nm-thick Ru and a 50-nm-thick Co10Ta5Zr film are formed to eventually provide an APC (anti-parallel coupling) structure. During formation of each film, the Ar pressure is kept constant at 0.6 Pa. Application power at the DC magnetron cathode is 2 kW for CoTaZa and 100 W for Ru. An underlayer 4 is of a dual structure including Ta and Ru. Film thickness is 3 nm for Ta and 15 nm for Ru, with the Ar pressure being 1 Pa and 4 Pa, respectively. To form a magnetic layer 5, the DC magnetron cathode is used. Adjustments are made to vary film formation time with a constant DC power of 500 W so that the film formation pressure may remain constant at 4.2 Pa and film thickness may remain constant at 15 nm. The target used is CoCrPt(15-18)+5 to 50 mol % SiC. The application power is kept at 500 W and the film formation time is varied so that the film thickness may become 15 nm as determined from the film formation speed. The sputtering gas used is Ar. A protective layer 6 is thereafter formed by RF-CVD. The pressure during film formation is 2.2 Pa and the amount of hydrogen is 20% relative to ethylene, thereby forming a DLC layer. The film thickness is set to 4 nm. The substrate is thereafter removed from the sputtering apparatus. A 1-nm-thick lubricant layer 7 is formed on the protective layer 6 by applying a lubricant having perfluoroalkylpolyether as a main component. Cleaning is then performed on the lubricant layer 7 using the same tape cleaning system, cleaning tape, pad, and tape cleaning conditions as in the first embodiment. Results of a comparison made between the case using the conventional pad and the case using the waffle pad according to the present embodiment will be described.

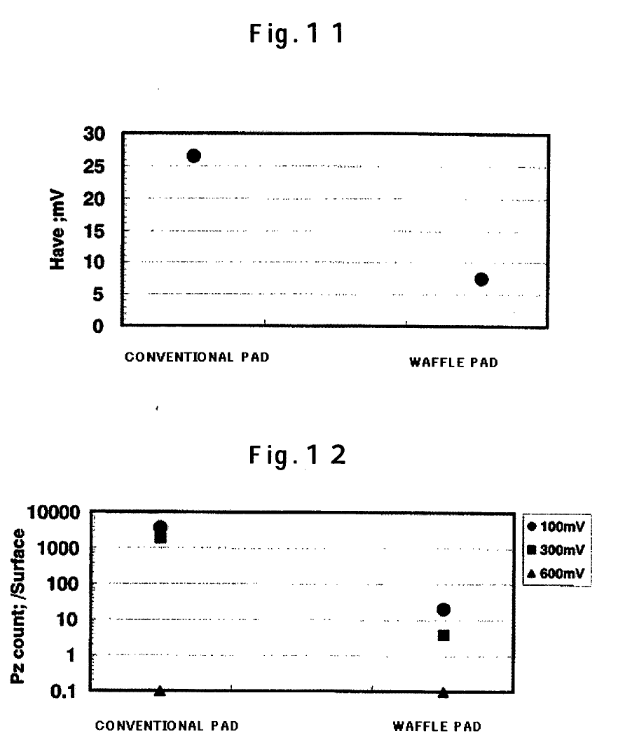

FIG. 11 shows the Have values (piezo element detection outputs: RMS values). The flying check conditions are the same as those for the first embodiment. The use of the conventional pad results in higher Have values. The Have value becomes substantially higher than the output value ranging between 8 and 10 mV, the range being considered as that allowing the glide check head to fly stably. That is the condition, in which what is called the glide noise occurs. It is seen, on the other hand, that, when the waffle pad according to the embodiment is used, stable flyability is maintained without allowing the glide noise to occur.

Referring to FIG. 12, the use of the waffle pad also substantially decreases the piezo count. That is, it is seen that the use of the waffle pad allows the protrusions that serve as a hindrance to flying to be efficiently removed without letting the glide noise occur.

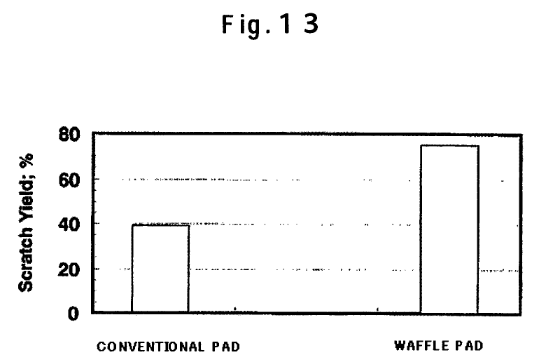

As an index for evaluating damage on the disk surface after cleaning, minor scratches were measured using the optical surface analyzer (OSA: TS-2120 manufactured by Candela Instruments). The results of the measurements are shown in FIG. 13. The ordinate representing “yield” of the chart is an acceptance rate which is taken as below. Specifically, the number of scratches having a circumferential-to-radial length ratio of 1 or more as detected in the S-Specular channel was zero on both sides of a total of 50 disks cleaned with each of the conventional pad and the waffle pad. Findings are as below. Specifically, when the conventional pad is used, the probability of occurrence of scratches is 60%. The use of the waffle pad according to the embodiment reduces the occurrence rate to 25%. This is indicative of a dramatic effect of a substantial reduction in the number of defects causing errors during read/write operations.

That is, the inventors found that the tape cleaning using the waffle pad according to the present invention can eliminate occurrence of the glide noise, remove effectively protrusions, and substantially suppress occurrence of scratches. The inventors thus invented the manufacturing method including the tape cleaning using the waffle pad according to the present invention.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A magnetic disk manufacturing method, comprising:
forming an underlayer on a substrate;
forming a magnetic layer on the underlayer;
forming a protective layer on the magnetic layer; and
cleaning the protective layer by rotating the substrate, on which the underlayer, the magnetic layer, and the protective layer are formed, with a pad made in contact with a cleaning tape disposed on the protective layer, thereby making the cleaning tape slide over the protective layer;
wherein a surface of the pad facing the cleaning tape is formed with protrusions and indentations.

2. The magnetic disk manufacturing method according to claim 1, wherein the protective layer is about 3 nm or less thick.

3. The magnetic disk manufacturing method according to claim 1, wherein the protective layer is about 2 nm or more thick and about 3 nm or less thick.

4. The magnetic disk manufacturing method according to claim 1, wherein the pad is made of an elastic body.

5. The magnetic disk manufacturing method according to claim 1, wherein the pad has a hardness of about 20 degrees or more and about 40 degrees or less.

6. The magnetic disk manufacturing method according to claim 1, wherein a ratio of an area of the indentations of the protrusions and indentations, of the surface of the pad facing the cleaning tape, is about 20% or more and about 80% or less.

7. The magnetic disk manufacturing method according to claim 1, wherein, of the protrusions and indentations of the pad, a surface of the protrusions facing the cleaning tape is quadrilateral in shape.

8. The magnetic disk manufacturing method according to claim 7, wherein a groove formed by the indentations of the pad is formed toward a combined direction of a radial direction of the magnetic disk and a direction tangential to the rotating direction with respect to a width direction of the cleaning tape.

9. The magnetic disk manufacturing method according to claim 1, wherein a dimension of a pad in a longitudinal direction of the cleaning tape is about 5 mm, while a dimension in a crosswise direction of the cleaning tape is about 4 mm.

10. The magnetic disk manufacturing method according to claim 1, wherein, in cleaning the protective layer, the rotating speed of the substrate is about 2 m/s or more and about 4 m/s or less.

11. The magnetic disk manufacturing method according to claim 1, further comprising applying a lubricant film on top of the protective layer after forming the magnetic layer and before forming the protective layer.

12. The magnetic disk manufacturing method according to claim 11, wherein a ratio of a thickness of a bonding layer formed of part of the lubricant film bonded to the protective layer to a thickness of the lubricant film is about 80% or less.

13. The magnetic disk manufacturing method according to claim 1, further comprising forming a soft magnetic layer on top of the underlayer before forming the magnetic layer.

14. A magnetic disk manufacturing method, comprising:
forming an underlayer on a substrate;
forming a magnetic layer on the underlayer;
forming a protective layer on the magnetic layer; and
cleaning the protective layer by rotating the substrate, on which the underlayer, the magnetic layer, and the protective layer are formed, with a pad made in contact with a cleaning tape disposed on the protective layer, thereby making the cleaning tape slide over the protective layer;
wherein a surface of the pad facing the protective layer has different hardness values depending on different portions thereof.

15. The magnetic disk manufacturing method according to claim 14, wherein the protective layer is about 3 nm or less thick.

16. The magnetic disk manufacturing method according to claim 14, wherein the protective layer is about 2 nm or more thick and about 3 nm or less thick.

17. The magnetic disk manufacturing method according to claim 14, wherein the pad is made of an elastic body.

18. The magnetic disk manufacturing method according to claim 14, wherein the pad has a hardness of about 20 degrees or more and about 40 degrees or less.

19. The magnetic disk manufacturing method according to claim 14, wherein, in cleaning the protective layer, the rotating speed of the substrate is about 2 m/s or more and about 4 m/s or less.

20. The magnetic disk manufacturing method according to claim 14, wherein the different portions of the surface of the pad facing the protective layer include protrusions and indentations.

21. A magnetic disk manufacturing method, comprising:
forming an underlayer on a substrate;
forming a magnetic layer on the underlayer;
forming a protective layer on the magnetic layer; and
performing tape cleaning of the protective layer by rotating the substrate, on which the underlayer, the magnetic layer, and the protective layer are formed, with a pad disposed on the protective layer kept in contact with the protective layer;
wherein a surface of the pad facing the protective layer is formed with protrusions and indentations.

22. A magnetic disk, comprising:
a substrate;
an underlayer formed on the substrate;
a magnetic layer formed on the underlayer;
a protective layer formed on the magnetic layer; and
a lubricant film applied on top of the protective layer;
wherein the protective layer is about 2 nm or more thick and about 3 nm or less thick; and
wherein a ratio of a thickness of a bonding layer formed of part of the lubricant film bonded to the protective layer to a thickness of the lubricant film is about 80% or less.
